(19) United States
(12) Patent Application Publication
(10) Pub. No.: US 2004/0197251 A1
(43) Pub. Date: Oct. 7, 2004

(54) Vaporization having fast start up

(75) Inventor: Richard I. Williamson, Houston, TX (US)

Correspondence Address: CONLEY ROSE, P.C., P. O. BOX 3267, HOUSTON, TX, 77253-3267, US

(73) Assignee: GLEX, Inc., Houston, TX

(21) Appl. No.: 10/408,793

(22) Filed: Apr. 7, 2003

(51) Int. Cl. B01D 53/56; B01D 53/58

(52) U.S. Cl. 423/235; 422/109; 423/237; 422/173

(57) ABSTRACT

A fast-start vaporization system is disclosed herein. In one embodiment, the fast-start vaporization system is part of a pollution control system that includes a vaporization chamber and a heat source. The heat source is configured to maintain the vaporization chamber at an elevated temperature (e.g., at least about 300° F.) when the vaporization chamber is idle. The heat source may be one or more band heaters disposed around a circumference of the vaporization chamber, and it may be disabled when the vaporization chamber is not idle. The pollution control system may further include one or more nozzles configured to disperse a liquid such as aqueous ammonia in a flow of carrier medium (e.g., hot air or flue gases) through the vaporization chamber. From the pollution control system, the mixture of gases may be injected into a flue gas stream in preparation for selective catalytic reduction.

### BACKGROUND

Electric power generating plants, along with many other industrial complexes, generally obtain their power from the combustion of fuels such as coal, oil, natural gas, petroleum coke, etc. The combustion process typically creates a flue gas stream that includes NO₂ and NO₃, commonly called NOₓ. Because these gases may be harmful to the environment, industries commonly use a selective catalytic reduction (SCR) system to remove NOₓ from the flue gas. The removal process involves introducing an ammonia reagent into the flue gas. The flue gas and the ammonia reagent travel through a catalytic converter that facilitates the breakdown of NOₓ into nitrogen (N₂), oxygen (O₂), and water. There are several known methods used to remove NOₓ from the flue gas in SCR reactors.

A first known method uses anhydrous ammonia in order to reduce NOₓ levels. The anhydrous ammonia is evaporated with either an electric source or with steam coils. The vaporized ammonia is then diluted with air in order to provide an adequate mass necessary to distribute the ammonia reagent evenly over a large ductwork cross-section. The diluted ammonia and air mixture is delivered to a grid of injection pipes located in the flue gas ductwork and upstream of a SCR catalyst bed. The injection pipes span the width of the flue gas duct and are closed at one end. The ammonia and air mixture is injected into the flue gas through nozzles or orifices that are sufficiently spaced along the injection pipes in order to provide an even distribution and thorough mixing of the ammonia with the flue gas. Major disadvantages associated with using this method include the safety concerns and precautions pertaining to the handling and storage of the anhydrous ammonia. Especially in highly populated areas, local government regulations often require that aqueous ammonia be used instead of anhydrous ammonia.

A second method for reducing NOₓ levels is to use an aqueous ammonia with an external heat source in order to evaporate the aqueous ammonia. The aqueous ammonia used is typically purchased in industrial grade form and is approximately 16-30% by weight ammonia and 84-70% by weight water. A dedicated heater, usually an electric resistive-type heater, is used to heat dilution air to a level which is adequate enough to vaporize the ammonia and water mixture (roughly 700° F. or above). A vaporization chamber or static mixer is the medium in which the phase change occurs. Usually, atomization air is required to assist in the break-up of the aqueous ammonia in order for fine droplets of the aqueous ammonia to enter the vaporization chamber. After vaporization, the ammonia and water air mixture exits the vaporization chamber and is delivered to an injection grid for injection into the flue gas as described previously.

A third method is to vaporize aqueous ammonia using the heat energy from the flue gas. This method comprises taking a hot slip stream of the flue gas from the ductwork, upstream of the SCR reactor, and in turn sending it through a vaporization chamber by means of a high temperature fan or blower. As described in the second known method above, the aqueous ammonia is injected into the vaporization chamber with atomization air in order to facilitate the phase change. As previously described, the ammonia-water-flue gas mixture exits the vaporization chamber and is delivered to an injection grid.

A fourth known method for selective catalytic reduction of NOₓ in a flue gas is to spray aqueous ammonia directly into the flue gas flow upstream of the SCR catalyst bed. In this method, the aqueous solution is sprayed into the flue gas upstream of the catalyst bed in a manner similar to the way reagent is introduced into a typical selective non-catalytic reduction process (SNCR), i.e., a liquid ammonia derivative is sprayed in high temperature regions (i.e. very near the combustion regions) of the furnace in order to accomplish NOₓ reduction. The energy from the flue gas is used to accomplish the phase change.

A major problem associated with this method is that great residence time is required in order to vaporize the water and ammonia. Additionally, there may be insufficient distance upstream of the catalyst bed for placing the injection pipes. This is further complicated by the requirement of protecting the SCR catalyst from liquid water in order to avoid contamination. This method also fails to address the need for appreciable carrier mass, which means that the number of total nozzles in the cross-section of the flue gas is limited. Thus, this method limits the capability to have a uniform injection distribution. The complications involved in this method may make it cost prohibitive to implement.

Thus, of the four methods described, the second and third may be preferred in view of safety concerns and cost considerations. Both of these methods employ vaporization chambers to vaporize the aqueous ammonia. However, these vaporization chambers only operate effectively when the carrier gases (i.e., the heated dilution air or hot flue gas slipstream) reach elevated temperatures (roughly 700° F. or above), and for a number of reasons, this often translates into an extended start-up delay when these methods are employed. These reasons include the heat capacity of the vaporization system, the rate of heat transfer from the carrier gases to the vaporization system, and the sheer magnitude of the minimum carrier gas temperature.

For industries that typically engage in fairly continuous operation, the extended delays of infrequent start-ups are not a significant concern. Conversely, industries that have frequent and unpredictable start-ups may be severely handicapped by such delays. One example of such an industry might be a “peak” power plant, that is, an electrical power plant that specializes in generating electrical power during periods of peak demand. Peak power plants make money by competing for contracts from the public utilities or private power providers when power demands exceed the generating capabilities of those companies. Timing is one of the major considerations made when awarding peak power contracts, i.e., how quickly can the power be provided. Those plants that are able to start up in under 15 minutes will have a major commercial advantage over those that require 75 minutes or more.

Accordingly, it is desired to provide a robust, cost-effective method for minimizing start-up delays of systems employing vaporization chambers, and to provide pollution control systems that employ this method.

### SUMMARY

A fast-start vaporization system is disclosed herein. In one embodiment, the fast-start vaporization system is part of a pollution control system that includes a vaporization chamber and a heat source. The heat source is configured to maintain the vaporization chamber at an elevated temperature (e.g., at least about 300° F.) when the vaporization chamber is idle. The heat source may be one or more band heaters disposed around the sides of the vaporization chamber, and it may be disabled when the vaporization chamber is not idle. The pollution control system may further include one or more nozzles configured to disperse a liquid such as aqueous ammonia in a flow of carrier medium (e.g., hot air or flue gases) through the vaporization chamber. From the pollution control system, the mixture of gases may be injected into a flue gas stream in preparation for selective catalytic reduction.

### BRIEF DESCRIPTION OF THE DRAWINGS

A better understanding of the present invention can be obtained when the following detailed description of the preferred embodiment is considered in conjunction with the following drawings, in which:

FIG. 1 shows an exemplary pollution control system in the context of a commercial furnace;

FIG. 2 shows one vaporization system embodiment;

FIG. 3 shows an alternative vaporization system embodiment; and

FIG. 4 shows a sequence of high-level vaporization system states.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

The following discussion first describes the context in which vaporization systems may be employed, then describes the operation of two embodiments in steady state conditions. Finally, the following discussion illustrates a robust, cost-effective method for minimizing start-up delays with respect to the two embodiments.

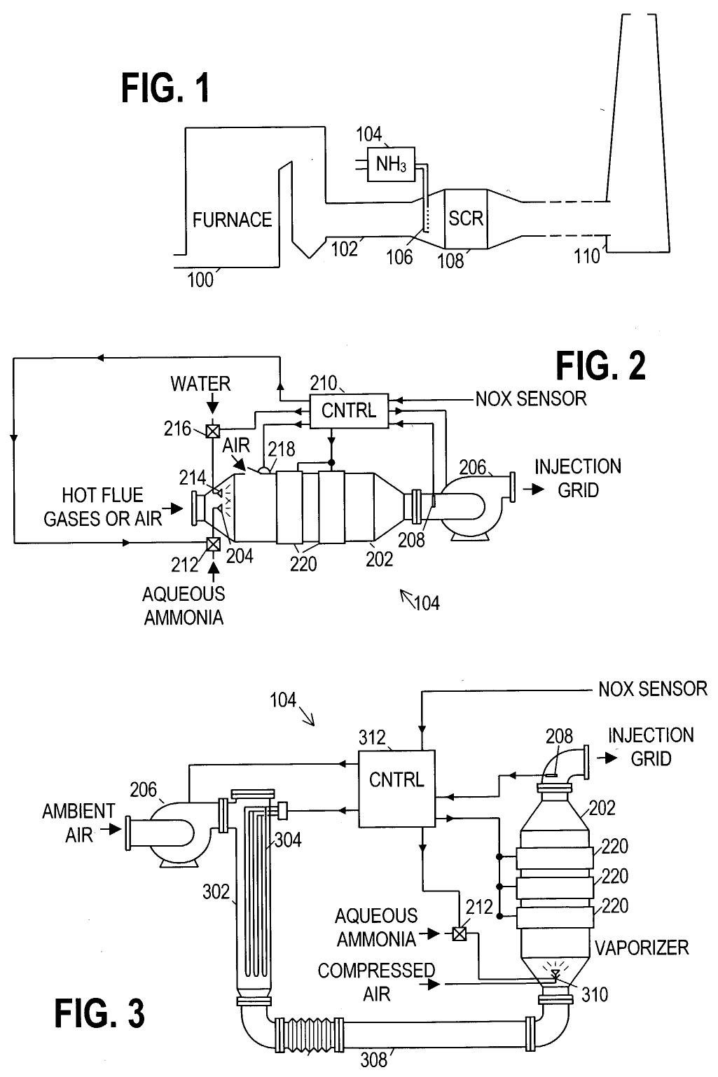

Turning now to the figures, FIG. 1 shows a furnace 100 in which the burning of combustible fuels occurs. This furnace may, for example, be part of a steam-generating boiler that drives a steam turbine or other power-generating mechanism. Gas byproducts of the combustion pass into a flue duct 102, past an ammonia vapor injection grid 106, through a selective catalytic reduction (SCR) region 108, and eventually out a stack 110 into the atmosphere. Injection grid 106 receives a mixture of gases including ammonia vapor from a vaporization system 104, described in more detail below. The diluted ammonia vapor mixes with the flue gases and as the mixture passes through the SCR region 108, the catalysts there cause the ammonia to react with the NOₓ in the flue gas to produce harmless byproducts of nitrogen and water vapor.

FIG. 2 shows one embodiment of vaporization system 104. The vaporization system 104 may take hot flue gases from duct 102 to use as a carrier medium for the ammonia vapor. However, as explained further below, other carrier mediums may alternatively be used including, e.g., heated air. During normal operations, the temperature of the carrier medium may generally be expected to exceed 700° F., and indeed, may be expected to reach between 800 and 900° F. (for flue gases) or may even exceed 1000° F. (for heated air).

As the carrier medium passes into a vaporizer 202, aqueous ammonia may be injected into the flow of carrier medium via an array of spray nozzles 204. As noted further below, compressed air may be used to atomize the sprays, further dispersing the aqueous ammonia as very fine droplets. Heat from the carrier medium is absorbed by the droplets of aqueous ammonia spray, causing the droplets to vaporize and at the same time reducing the carrier medium temperature. The temperature of the gas mixture leaving the vaporizer 202 is expected to fall below 300° F., and in this embodiment, may be limited to less than 350° F. during normal operation.

Motion of the carrier medium into and through the vaporizer 202 may be induced by a blower 206 located downstream from the vaporizer and upstream from the injection grid 106. It is noted that this placement of the blower 206 advantageously reduces the performance requirements of the blower when employing flue gases as the carrier medium. If the blower were placed upstream of the vaporizer, it would have to cope with much higher operating temperatures and flow volumes of the flue gas slipstream.

A controller 210 is preferably provided to ensure optimal NOₓ removal with minimal wastage of aqueous ammonia. It may include an input from a NOₓ sensor downstream from the SCR region 108, which the controller 210 may use in a feedback control technique. The controller 210 regulates the flow of injected aqueous ammonia, preferably via a valve 212, to provide the optimum amount of diluted ammonia through the injection grid.

Since blower 206 may be rated for lower temperature operation, various embodiments of the vaporization system include means to protect the blower 206 by preventing the temperature of the carrier medium exiting the vaporizer 202 from exceeding the rated temperature, e.g. 350° F. To this end, the controller 210 may be provided with a temperature sensor 208 near the inlet of blower 206. If the temperature sensor indicates that the operating temperature of the blower is approaching or exceeding a threshold temperature, the controller 210 can actuate one or more systems to reduce the operating temperature.

A first way that may be used to reduce the operating temperature of the blower is a second injector 214 that injects water into the vaporizer. If the temperature is rising because the aqueous ammonia flow has been reduced, the controller may compensate by opening valve 216 to inject more water into the vaporizer. The increased mass of water being vaporized by the carrier medium will cool the mixture entering the blower 206. A second way that may be used to reduce the operating temperature of the blower 206 is a damper 218. Opening the damper allows ambient air to enter the vaporizer 202 and dilute the carrier medium. This will also cool the mixture entering the blower 206. Yet another way that may be used to reduce the operating temperature of the blower 206 is to alter the blower speed. Slowing or stopping the blower 206 will slow the movement of the carrier medium, thereby allowing more complete vaporization of injected fluids, and/or allowing heat loss through the walls of the vaporizer 202 and upstream ducts of vaporization system 104. Through any one of these or other methods or combinations thereof, controller 210 may limit the operating temperature of the blower 206.

Band heaters 220 are part of the rapid start enabling subsystem, and will be described later.

FIG. 3 shows another embodiment of vaporization system 104. In this embodiment, blower 206 pushes ambient air or some other carrier medium into a heater 302. Heater 302 may include electrical resistance heating coils 304 or some other heat energy source. In one embodiment, heating coils 304 jointly provide 100 kW of heat energy. Heater 302 may be expected to heat the carrier medium to over 700° F., and may preferably heat the carrier medium to over 1000° F. The carrier medium flows from heater 302 to vaporizer 202 through a minimum of intervening ductwork. The intervening ductwork may include an expansion section 306 to allow for heat-induced expansion and contraction of the heater 302. Duct 308 is included solely for illustrative purposes, and may preferably be excluded to minimize heat loss between heater 302 and vaporizer 202.

As before, aqueous ammonia may be injected into the carrier medium flow via an array of spray nozzles 310. Note that the use of atomization air is specifically shown in FIG. 3, but as previously noted, may not be necessary. Compressed air may aid in atomizing the injection sprays into very fine droplets, thereby enhancing dispersion of the aqueous ammonia in the carrier medium. The droplets of aqueous ammonia absorb heat from the carrier medium and vaporize, reducing the temperature of the carrier medium in the process. The gas mixture is then directed to the injection grid 106 for dispersal in the flue gas stream.

Controller 312 monitors measurements from the NOₓ sensor and the temperature sensor 208, and may responsively control the aqueous ammonia injection, the temperature of heater 302, and the speed of blower 206. The aqueous ammonia injection is preferably controlled to optimize NOₓ removal and avoid ammonia wastage. The blower speed and heater temperature may be controlled in accordance with the injection rate.

Moving now to the issue of minimizing start-up delays, consider the issues involved in reaching steady-state operating conditions. The issues may include raising the temperature of the vaporization system from ambient to steady-state. The vaporization system may be analytically divided into three portions: upstream of the vaporizer, the vaporizer itself, and downstream of the vaporizer. The steady-state temperature of the upstream portion may approach or exceed 1000° F. The steady-state temperature of the vaporizer may be somewhat more than 300° F. The downstream portion may fall below 300° F., depending on a number of factors. Of the three portions, the upstream temperature may be considered most important, as effective operation of the vaporizer requires that the carrier medium be above some minimum temperature as it enters the vaporizer. The temperature of the vaporizer may also be considered fairly important, as vaporization may be inhibited by any cooling effect on the carrier medium caused the body of the vaporizer itself. The downstream temperature may be considered the least important, as it need only be high enough to avoid undue condensation of the vaporized aqueous ammonia.

After some experimentation, it has been determined that it would be infeasible to provide sufficient heating capacity to quickly raise the temperatures of the various components from ambient. Further, the power requirements would be prohibitive to continuously maintain the entire system at operating temperatures. However, the bulk of these power requirements are attributable to the upstream portion, and it has been found practical to continuously maintain the vaporizer at a temperature of around 325° F. Further, (at least in the heated-air embodiment) it has been determined that the air temperature at the vaporizer inlet reaches the minimum temperature within about 10 minutes from a cold start. Accordingly, a drastic reduction in start-up time may be achieved by continuously maintaining the vaporizer at an elevated temperature.

Accordingly, the vaporization system embodiments of FIG. 2 and FIG. 3 each include one or more heaters 220 disposed about the body of vaporizer 202. The heaters 220 may be electrical resistance heaters, and in particular, they may be band heaters such as those available from Gaumer Co. in Houston, Tex., part nos. 2GTB-240-4-LT and 2GTB-240-4-LT-KOP, which are 2-part band heaters with a 24 inch diameter and rated at 5 kW at 480 V. They provide up to 23 watts per square inch, and are available with liquid-tight housings and thermocouples. In one contemplated configuration, three band heaters are employed, two without thermocouples, and one with a thermocouple. Of course, other heat sources may also be used to maintain the vaporizer 202 at an elevated temperature.

A layer of one-eight or one-quarter inch-thick copper metal sheeting may be disposed between the band heaters and the body of vaporizer 202 to aid in even heat distribution. (This may be particularly desirable when the body of vaporizer 202 is made of carbon steel.) A tensionable stainless steel band may be used to “capture” the heating elements and copper layer and hold them in contact with the vaporizer body.

The vaporizer 202 and heaters 220 may be surrounded by one or more layers of thermal insulation (not shown) to minimize heat loss from the vaporizer. Such insulation may also be applied to other portions of the vaporization system 104. Additional insulation on the upstream portion of vaporization system may aid in further reducing start-up delays.

The temperature at which the heaters maintain the vaporizer depends on a number of factors. In one implementation, the temperature may be 300° F. or less, in another, it may be 350° F. or more. A preferred temperature may be a minimum steady-state temperature at which the vaporizer operates efficiently.

In one contemplated embodiment, heaters 220 are on continuously, during both periods of idleness (i.e., no carrier medium flow) and active operation (i.e., a carrier medium flow is present). In an alternative embodiment, controllers 210 or 312 control the operation of heaters 220, turning them off when the vaporization system is actively operating, and turning them on when the system becomes idle.

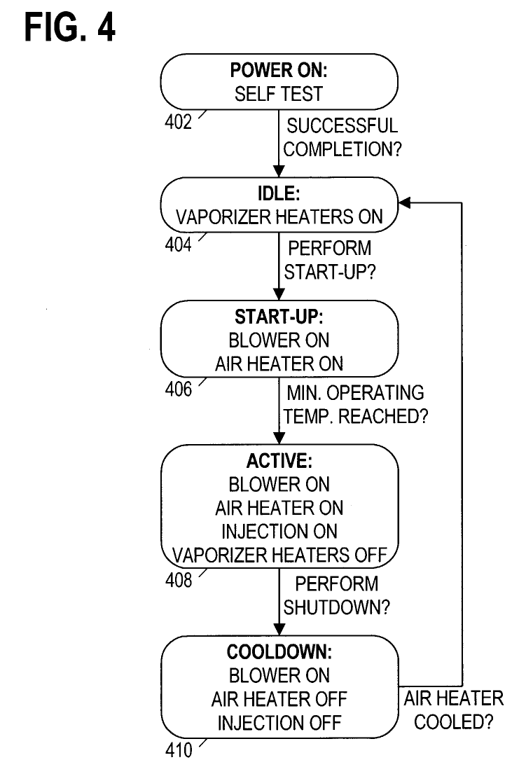

FIG. 4 shows a sequence of high-level system states that may be determined by the controller. State 402 is a power on state, in which the controller may conduct a series of tests to verify that the vaporization system is operational. Upon successful completion of the tests, the system enters idle state 404. In this state, heaters 220 are on while the remainder of the system remains idle. If the system remains in this state for any length of time, the temperature of the vaporizer 202 will be elevated to a predetermined value, e.g. 325° F.

When a system start-up is initiated, the system enters start-up state 406. In the context of FIG. 3, this may involve turning on blower 206 and heating coils 304. The controller monitors the temperature of the carrier medium entering vaporizer 202 (possibly via sensor 208) and enters active state 408 when a temperature threshold has been reached. Recalling that the temperature of the carrier medium will drop once aqueous ammonia injection commences, 700° F. might be one example of a potentially suitable temperature threshold.

In active state 408, heaters 220 are off, blower 206 is on, heating coils 304 are on, and injection via nozzle 310 commences. The injection rate may be determined by the controller in accordance with measurements from the NOₓ sensor. The system continues in active operation until a shutdown is desired. At that point, the system may enter cool down state 410, in which injection is discontinued, the heating coils 304 are off, and the blower remains on. The blower stays on until the heating coils have cooled sufficiently to avoid damage, at which point the system returns to idle state 404.

Numerous variations and modifications will become apparent to those skilled in the art once the above disclosure is fully appreciated. It is intended that the following claims be interpreted to embrace all such variations and modifications.

What is claimed is:

1. A fast-starting pollution control system that comprises:
a vaporization chamber; and
a heat source configured to maintain the vaporization chamber at an elevated temperature when the vaporization chamber is idle.

2. The system of claim 1, further comprising:
one or more nozzles configured to disperse aqueous ammonia in a flow of carrier medium through the vaporization chamber.

3. The system of claim 1, wherein when not idle, the vaporization chamber accepts a flow of carrier medium.

4. The system of claim 3, wherein the carrier medium is heated air.

5. The system of claim 3, wherein the carrier medium is a flue gas slipstream.

6. The system of claim 1, wherein the elevated temperature approximates a steady state temperature of the vaporization chamber during vaporization.

7. The system of claim 1, wherein the elevated temperature is about 300° F. or more.

8. The system of claim 7, wherein the elevated temperature is about 325° F. or more.

9. The system of claim 7, wherein the elevated temperature is about 350° F. or more.

10. The system of claim 1, wherein the heat source comprises one or more band heaters disposed around a circumference of the vaporization chamber.

11. The system of claim 1, further comprising:
a controller configured to control the system, wherein the controller is configured to enable the heat source when the vaporization chamber is idle, and is configured to disable the heat source when the vaporization chamber is not idle.

12. A fast-start pollution control method that comprises:
when the vaporization chamber is receiving a flow of carrier medium, vaporizing a liquid within the carrier medium flow; and
when the vaporization chamber is not receiving a flow of carrier medium, maintaining the vaporization chamber at an elevated temperature.

13. The method of claim 12, wherein the carrier medium comprises flue gas.

14. The method of claim 12, wherein the carrier medium comprises heated air.

15. The method of claim 12, wherein the fluid comprises aqueous ammonia.

16. The method of claim 12, wherein the elevated temperature is at least about 300° F.

17. The method of claim 12, further comprising:
directing the flow of carrier medium with vaporized liquid through an injection grid into a flue gas flow upstream of a selective catalytic reduction region.

18. A vaporization chamber that comprises:
a chamber body having an inlet and an outlet;
one or more nozzles configured to disperse a liquid into a carrier medium flow through the chamber body; and
one or more band heaters disposed around the chamber body and configured to continuously maintain the chamber body at temperature significantly above ambient.

19. A controller for a pollution control system, the controller comprising:
an input for measurements from a NOₓ sensor,
an input for measurements from a vaporization chamber temperature sensor;
an output for controlling a flow of aqueous ammonia;
an output for controlling a blower; and
an output for controlling a vaporization chamber heater,
wherein the controller is configured to control an operating state of the pollution control system, and
wherein when the operating state is an idle state, the controller is configured to enable the vaporization chamber heater to continuously maintain the vaporization chamber at a temperature significantly above ambient.

20. The controller of claim 19, wherein when the operating state is an active state, the controller is configured to dynamically control the blower and flow of aqueous ammonia in response to measurements from the NOₓ and temperature sensors, and is further configured to disable the vaporization chamber heater in the active state.

21. The controller of claim 20, wherein the controller is configured to transition the operating state from the idle state to the active state via a start-up state, and wherein the controller is configured to transition from the start-up state to the active state only when the temperature sensor indicates that a carrier medium flow has reached at least about 700° F.
